(19) United States
(12) Patent Application Publication
(10) Pub. No.: US 2004/0048038 A1
(43) Pub. Date: Mar. 11, 2004

(54) Pad member used in operating computer

(76) Inventor: Hui-Min Tseng, Taichung (TW)

Correspondence Address: BROWDY AND NEIMARK, P.L.L.C., 624 NINTH STREET, NW, SUITE 300, WASHINGTON, DC, 20001-5303, US

(21) Appl. No.: 10/235,866

(22) Filed: Sep. 6, 2002

(51) Int. Cl. B32B 3/10

(52) U.S. Cl. 428/131; 428/174

(57) ABSTRACT

A pad member used in operating computer has a substrate made of a soft yet firm material. A pedestal bulges from the upper surface of the substrate such that a hollow portion is formed thereunder. A friction surface layer is attached on the upper surface of said substrate. The substrate and the surface layer have a plurality of apertures respectively. A base layer with a flat bottom surface is attached on the bottom surface of the substrate.

### FIELD OF THE INVENTION

The present invention relates to a computer peripheral product, and more particularly to a pad member used in operating computer, such as mouse pad or wrist pad.

### BACKGROUND OF THE INVENTION

In earlier days, a mouse pad was flat which is constructed from a rubber pad and a cloth layer or a plastics layer attached on the rubber pad. The rubber pad rests on the table and mouse runs on the cloth layer or the plastics layer.

Such mouse pad did not provide user's wrist any support so that user will fell uncomfortable on wrist after a long time use. An improved mouse pad was provided with a soft bump for resting user's wrist on it. Such that user can bear operating mouse for a longer time.

Recently, a wrist pad was brought to the market which is a single soft bump element for user can rest his/her wrist on it. For example, user can use the wrist pad when he/she operates a digit plate, or user can put a bar-like wrist pad in front of a keyboard to support his/her wrists when operates the keyboard.

The conventional pad, including mouse pad or wrist pad etc., usually had a soft bump made of gel. The bump is made from injection molding or pressing for providing a well elasticity to support wrist. Such gel bump has a higher cost so that a pad with the gel bump is expensive and the gel bump does not allow ventilation so that user will feel hot and uncomfortable when rests his/her wrist on it for a long time.

In addition, the conventional pad is easy to accumulate dust on it. The dust will be attached on the ball on the bottom of the mouse. That will make the mouse cannot work normally. Such that, user needs to disassemble the ball to clean it frequently.

### SUMMARY OF THE INVENTION

It is the primary objective of the present invention is to provide a pad member used in operating computer, which costs less and can support user's wrist well when he/she operates computer.

It is another objective of the present invention is to provide a pad member used in operating computer, which allows ventilation when a user rests his/her wrist on it.

It is still another objective of the present invention is to provide a pad member used in operating computer, which can prevent dust accumulation.

According to the present invention, the above objectives are accomplished by a pad member used in operating computer comprising a substrate made of a soft yet firm material, a pedestal bulging from the upper surface of said substrate such that a hollow portion is formed thereunder, and a friction surface layer attached on the upper surface of said substrate. For having a hollow portion under the pedestal, the pad allows the pedestal having a suitable resilience to match user's wrist resting thereon and give the wrist a well support. In the mean time, the producing cost of the pad can be substantially reduced.

In another aspect of the present invention, the substrate of the pad has a plurality of first apertures running through the body thereof. The friction surface layer has a plurality of second apertures communicating with said first apertures. The combination allows ventilation when a user rests his/her wrist on it and that the dust accumulated on the bottom of a mouse can be scraped by the friction surface layer and dropped to outside through the apertures.

A further understanding of the nature and advantages of the invention may be realized by reference to the remaining portions of the specification and the drawings.

### BRIEF DESCRIPTION OF THE DRAWINGS

FIG. 1 is a perspective view of a first embodiment of the present invention;

FIG. 2 is a sectional view taken along the direction indicated by a line 2-2 as shown in FIG. 1 and a side view of the wrist and hand location when resting on the pedestal of the pad;

FIG. 3 is a perspective view of a second embodiment of the present invention;

FIG. 4 is an exploded view of the second embodiment of the present invention;

FIG. 5 is a bottom view of in part of the base layer of the second embodiment of the present invention;

FIG. 5A is an enlarged view of A portion of FIG. 5;

FIG. 6 is a sectional view of the second embodiment of the present invention, and

FIG. 7 is a perspective view of a third embodiment of the present invention.

### DETAIL DESCRIPTION OF THE INVENTION

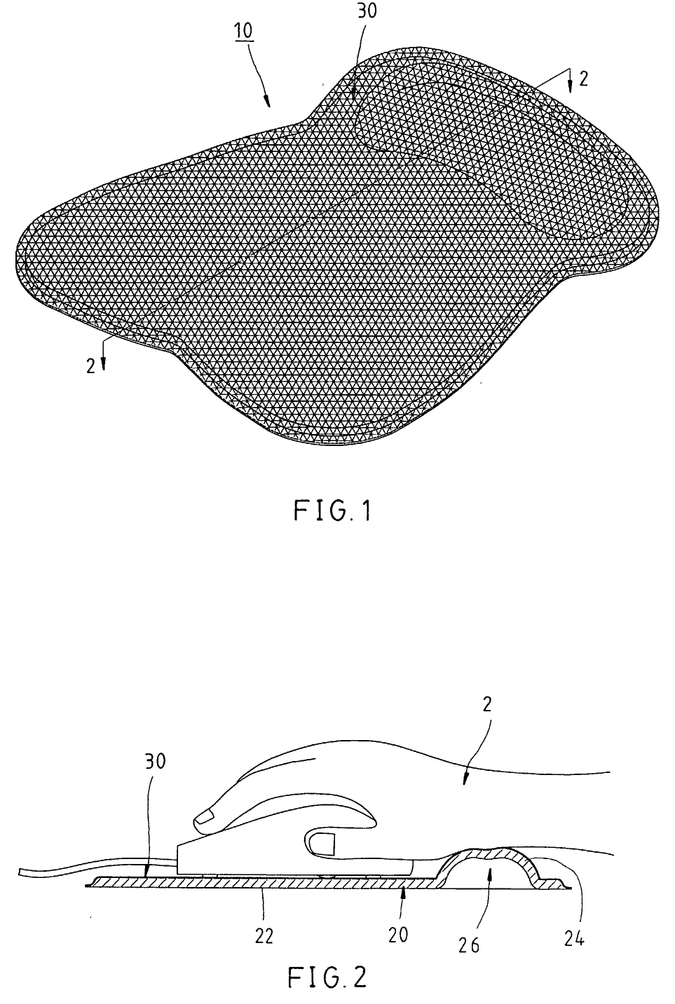

Referring to FIG. 1 and FIG. 2, a pad 10 has a substrate 20 and a surface layer 30. Substrate 20 is formed from a suitable soft yet firm material such as any of various commercially available plastic materials. Substrate 20 has a flat portion 22 and a pedestal 24 bulging from the upper surface thereof such that a hollow portion 26 is formed under pedestal 24. Surface layer 30, which is made of a sheet material having a suitable roughness and allowing ventilation, such as a non-weaved cloth, is attached on the upper surface of substrate 20 to provide a friction and ventilating surface on pad 10.

For having hollow portion 26 thereunder, pedestal 24 will have a suitable resilience to allow it can be deformed properly according to the weight and shape of user's wrist 2 resting thereon. In other words, pedestal 24 provided by the present invention allows matching user's wrist resting thereon and giving the wrist a well support. Furthermore, since there is no other material needed to form a pedestal, the producing cost of pad 10 can be reduced remarkably.

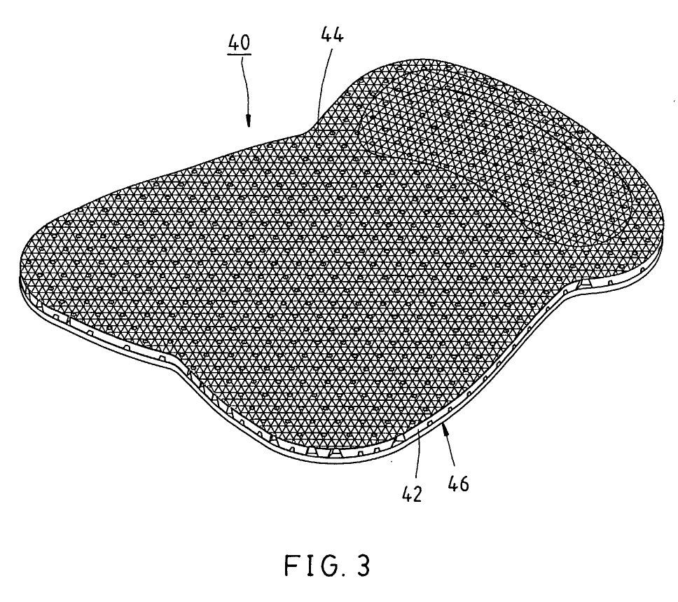

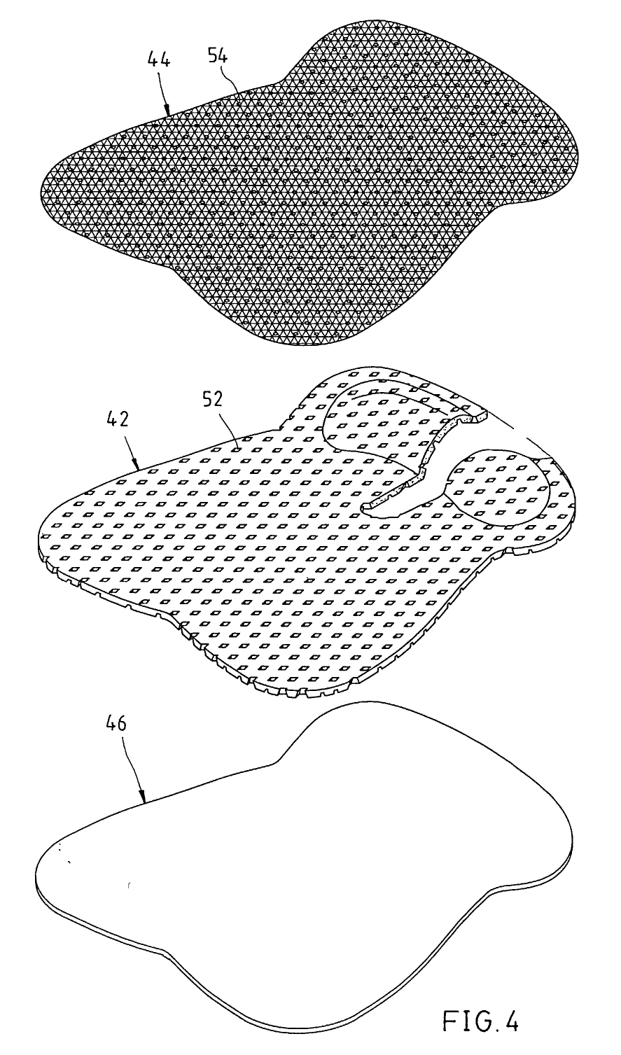

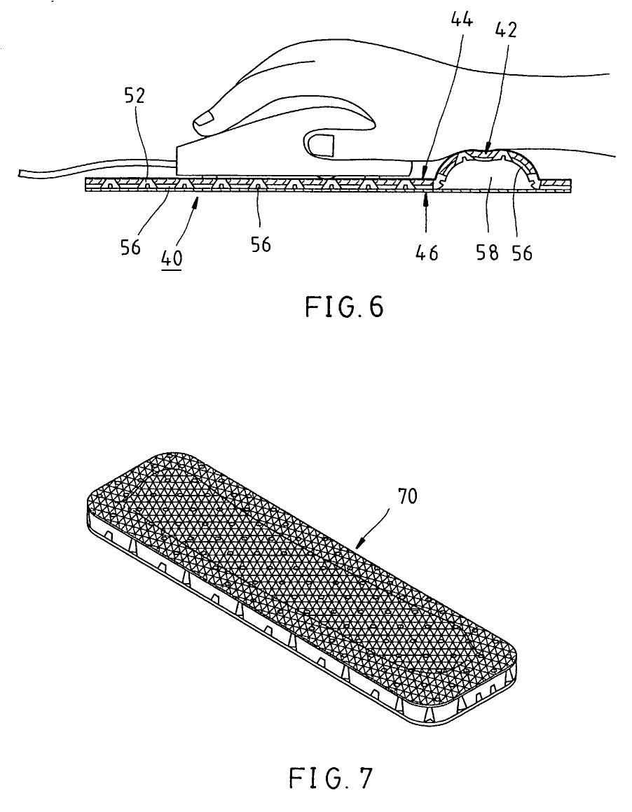

Another variation of the pad according the present invention is illustrated in FIGS. 3 through 6. In the variation version, pad 40 has a substrate 42, a surface layer 44 attached on the upper surface of substrate 42, and a base layer 46 attached on the bottom surface of substrate 42.

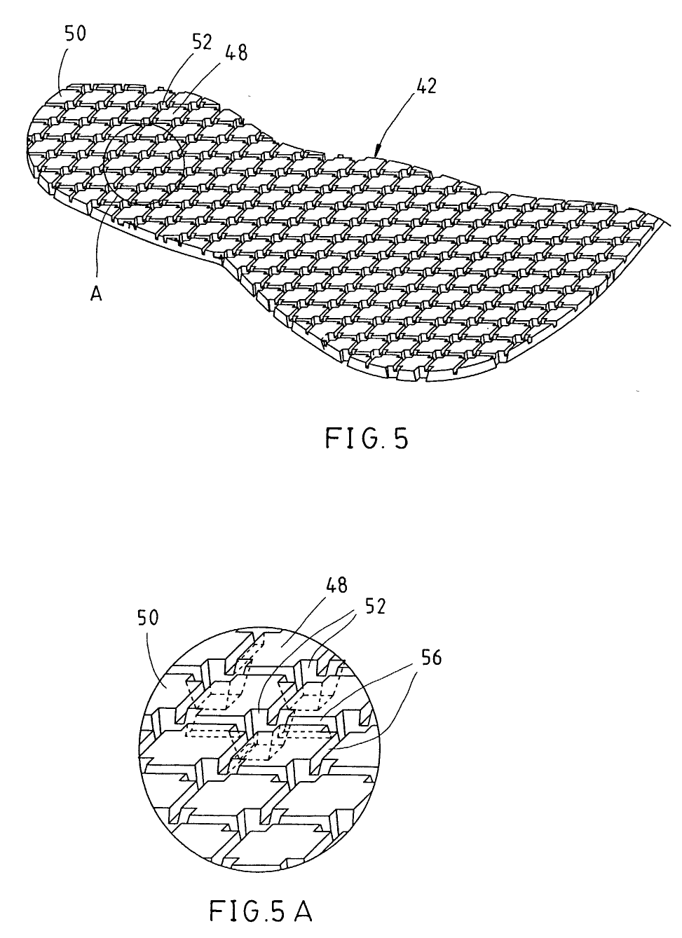

Substrate 42 can be designed to have a plurality of apertures thereon such as a meshed structure or the similars. In this embodiment, Substrate 42 has parallel first ribs 48 and parallel second ribs 50 arranged in a crisscross pattern such that apertures 52 are formed therebetween (as shown in FIG. 5). Surface layer 44 is provided with apertures 54 relative to apertures 52 of substrate 42. Such a combination has several advantages. The first is that substrate 42 is more resilient than the substrate having no apertures, so pedestal 56 with a hollow portion 58 provides user's wrist a more comfortable support than prior art pads. The second is that pad 40 allows ventilation. The third is that when pad 40 is used, the dust accumulated on the bottom of a mouse, specially the ball thereof, can be scraped by surface layer 44 and dropped to outside through apertures 52 and 54.

For providing better ventilation, the bottom surface of the substrate may be designed to have a plurality of ventilated channels communicating apertures formed on the substrate. As shown in FIGS. 5 and 5A, in the embodiment, such ventilated channels are accomplished by gaps 56 formed on ribs 48 and 52.

Base layer 46 is a flat piece having a planar bottom surface and attached to the bottom surface of substrate 42. Base layer 46 allows that, pad 40 can be securely attached on a working face.

Referring to FIG. 7, according to the present invention, pad 70 can be an elongated member for being a keyboard pad.

What is claimed is:

1. A pad member used in operating computer, comprising:
a substrate made of a soft yet firm material,
a pedestal bulging from the upper surface of said substrate such that a hollow portion is formed thereunder to allow said pedestal having suitable resilience to match user's wrist resting thereon and give the wrist a well support, and
a friction surface layer attached on the upper surface of said substrate.

2. The pad member as defined in claim 1, further comprising a base layer having a planar bottom surface and attached to the bottom surface of said substrate.

3. The pad member as defined in claim 1 or 2, Wherein said substrate has a plurality of first apertures running through the body thereof and said friction surface layer has a plurality of second apertures communicating with said first apertures.

4. The pad member as defined in claim 1 or 2, Wherein said substrate forms a meshed structure and said friction surface layer has a plurality of apertures communicating with the meshes of said meshed structure.

5. The pad member as defined in claim 3, Wherein said substrate further comprises a plurality of ventilated channels disposed on the bottom surface thereof and communicating with the first apertures thereof.

6. The pad member as defined in claim 4, Wherein said substrate further comprises a plurality of ventilated channels disposed on the bottom surface thereof and communicating with the meshes of said meshed structure.

7. The pad member as defined in claim 3, wherein said substrate comprises a first and second rib arranged in a crisscross pattern and said apertures are formed between said ribs.

8. The pad member as defined in claim 7, wherein said ribs are provided with gaps communicating said apertures of said substrate.
